(19) United States
(12) Patent Application Publication
(10) Pub. No.: US 2024/0075675 A1
(43) Pub. Date: Mar. 7, 2024

(54) Detecting lost plastic preforms in the heating module by multiple heating lamp failure detection

(71) Applicant: KRONES AG, Neutraubling (DE)

(72) Inventors: Daniel VOGLER, Neutraubling (DE); Michael EIFLER, Bernhardswald (DE); Thomas PHILIPP, Eilsbrunn (DE); Andreas PENSE, Obertraubling (DE); Simon MOEWES, Regensburg (DE); Andreas ROTH, Erlangen (DE); Wolfgang SCHOENBERGER, Brennberg (DE); Robert AUST, Ilkofen (DE); Jochen FORSTHÖVEL, Regensburg (DE); Daniel PETER, Hemau (DE)

(21) Appl. No.: 18/462,282

(22) Filed: Sep. 6, 2023

(30) Foreign Application Priority Data
Sep. 6, 2022 (DE) 10 2022 122 633.6

(51) Int. Cl. B29C 49/64; B29C 49/42; B29C 49/68

(52) U.S. Cl. CPC B29C 49/6418; B29C 49/42065; B29C 49/6835; B29C 2049/7861

(57) ABSTRACT

Disclosed is an apparatus for heating plastic preforms, having a transport device which transports the plastic preforms along a predetermined transport path, the transport device having a circulating transport and a plurality of holding devices for holding the plastic preforms, having a plurality of heating devices which are arranged stationarily along the transport path, in such a way that the plastic preforms transported along the transport path are heated by these heating devices, the heating devices each having a plurality of heating lamps, and the apparatus having a detection device which is configured to detect a failure of the heating lamps, wherein the apparatus has a control device which is configured to control the apparatus in dependence on a number of heating lamps detected having failed.

### BACKGROUND OF THE INVENTION

The present invention relates to an apparatus and a method for forming plastic preforms into plastic containers. Such apparatuses and methods have been known in the prior art for a long time. It is known that plastic preforms are first heated and then these heated plastic preforms are formed into the plastic containers, for example by means of a stretch blow-moulding machine. During the heating process in the heating apparatus, the plastic preforms are placed with their mouths on heating mandrels and are moved along standing or stationary heating boxes or heating devices and are preferably rotated about their middle axis in order to be heated evenly over the circumference.

It can happen that a plastic preform slips off the heating mandrel and falls into an oven lane. There it can then collide and fuse with subsequent plastic preforms and form a veritable lump, causing major machine damage in this way. This can cause a fire hazard, breakage of heating lamps and damage to components of the oven lane. In addition, bending of the heating mandrels and shielding plates can also occur.

In the prior art, it is known that to detect a falling down of such plastic preforms only within the blow module or at an inlet light barrier to the blow wheel.

In the prior art, a lost plastic preform cannot be detected directly during the entire heating process. This only happens later in the blow module or at the inlet light barrier, which may result in a time delay of 20 seconds.

This problem has recently been exacerbated by the fact that efforts are being made to make the heating lanes narrower and narrower and to bring the bottom reflectors closer and closer to the plastic preforms in order to increase the energy yield.

The present invention is therefore based on the task of detecting a falling down of plastic preforms as quickly as possible in order to prevent major damage to the heating module in this way.

### SUMMARY OF THE INVENTION

An apparatus according to the invention for heating plastic preforms has a transport device which transports the plastic preforms along a predetermined transport path. The transport device has a circulating transport means and a plurality of holding devices for holding the plastic preforms (whereby these holding devices are preferably arranged on the circulating transport means).

In addition, a plurality of heating devices is provided, which are arranged stationary along the transport path of the plastic preforms in such a way that the plastic preforms transported along the transport path are heated by these heating devices and in particular by infrared radiation emitted from these heating devices. The heating devices each have a plurality of heating lamps and the apparatus has a detection device which is suitable and intended to detect a failure of the heating lamps.

According to the invention, the apparatus comprises a control device suitable for controlling the apparatus in dependence on a number of heating lamps detected having failed.

A plastic preform lost in the heating device (or clumping of adjacent preforms due to, for example, thumb impact) also often causes collisions within the oven lane, causing multiple heating lamps to break. The invention proposes to use the detection of multiple broken heating lamps during production to control the apparatus. As described in more detail below, an emergency stop can be triggered in this case, preventing even greater damage to the machine.

It is therefore proposed to detect not only a failure of a heating lamp, but also a number of failures and in particular a number of failures in a certain time interval.

Particularly preferably, each heating device has several heating lamps which are arranged one above the other, in particular in a vertical direction or a longitudinal direction of the plastic preforms to be heated.

Particularly preferably, it is also possible to detect which specific heating lamp has failed. Particularly preferably, the heating lamp extends in the transport direction of the plastic preforms.

Particularly preferably, the apparatus has a rotating device which rotates the plastic preforms during their transport with respect to their longitudinal direction. Preferably, this rotating device causes a uniform rotation of all plastic preforms to be heated.

In a further preferred embodiment, the apparatus comprises a detection device which detects a time interval between the failures of at least two heating lamps.

For example, it would be conceivable that two heating lamps fail at a comparatively large time interval, which would then not indicate a fallen plastic preform, but possibly an “ordinary” (i.e. in particular not caused by a collision) failure of the lamps.

Furthermore, it can also be taken into account at which positions heating lamps have failed. For example, if an earlier heating lamp along the transport path fails first and then a later heating lamp along the transport path, this is more likely to indicate that a plastic preform has fallen down than if a heating lamp further along the transport path fails first and then an earlier heating lamp.

In a preferred embodiment, the apparatus has a first heating lane through which the plastic preforms are transported or can be transported during their heating. Particularly preferably, the apparatus has a second heating lane through which the plastic preforms are transported in the opposite direction. Particularly preferably, there is a deflection area between the first heating lane and the second heating lane, in which a direction of movement of the plastic preforms is reversed.

In a further preferred embodiment, a plurality of the heating lamps is arranged on one side of the heating lane. Particularly preferably, at least one reflector device that reflects infrared radiation is arranged on the opposite side of the heating lane.

In a further preferred embodiment, a plurality of reflector devices are arranged in the heating lane, which are suitable and intended to reflect thermal radiation, whereby floor reflector devices are also preferably provided, which are arranged below the plastic preform to be transported.

In a further advantageous embodiment, the floor reflector devices have, at least in sections, a course that deviates from a horizontal course.

This design serves in particular to make the heating lane as small as possible in order to make the heating of the plastic preforms more energy efficient. However, this approach also has the disadvantage that falling plastic preforms can cause damage to the heating device even more quickly, as collisions occur more easily.

In the prior art, the heating of the plastic preforms is mostly done with flat bottom tiles or flat bottom reflectors. This leads to a comparatively low efficiency of the heating device due to a larger radiation space in the heating lane (caused by the flat bottom tiles).

Therefore, the radiation space is only insufficiently adapted to the size of the plastic preforms. The design of the bottom reflectors described here increases the efficiency of the heating device.

Within the scope of the invention, floor reflectors or floor tiles are therefore proposed which minimize the non-functional dead space in the heating lane.

Preferably, the above-mentioned course on the surface facing the plastic preform is at least in sections deviating from a straight course, for example curved.

Preferably, the bottom reflector devices are curved at least in sections, (in particular spherically curved) or (oblique with respect to a horizontal direction).

Preferably, however, the bottom reflectors also have a horizontal course in sections. In particular, the bottom reflectors have a horizontal course on a side facing the heating lamps.

Preferably, the contour of the bottom reflectors on the surface facing the plastic preforms is selected from a group of contours comprising spherical contours, flat-spherical contours, combinations of several flat surfaces and the like.

Preferably, the bottom reflectors are height-adjustable and, in particular, adjustable in a longitudinal direction of the plastic preforms. In a preferred embodiment, the bottom reflectors or the bottom reflector devices can be controlled and/or adjusted and/or moved, in particular automatically, as a function of a number of the detected failed heating lamps of the apparatus. Here it is conceivable that in the event that several heating lamps have failed and/or an emergency stop is triggered, the bottom reflector devices are automatically moved to the lowest position. It would also be conceivable that the bottom reflector devices are already moved to the lowest position when one heating lamp fails. Preferably, the number of failed heating lamps at which the bottom reflector devices are automatically moved into the lowest position can be set by a user. It would also be conceivable that if one or more heating lamps fail, the user is informed and must confirm or reject automatic lowering to the lowest position.

In a preferred or alternative embodiment, the bottom reflectors or the bottom reflector devices are arranged so that they can swivel and, in particular, can be swiveled away from the transport path of the plastic preforms. In this case, it is conceivable that in the event that several heating lamps have failed and an emergency stop is triggered, the bottom reflector devices are automatically swiveled out of or away from the transport path of the plastic preforms, whereby the plastic preforms can preferably simply fall out of the oven without forming a lump or causing further damage.

In a preferred embodiment, the bottom reflectors or the floor reflector devices are preferably automatically adjustable and/or movable at least in sections depending on a number of the detected failed heating lamps of the apparatus. Here it is conceivable that the bottom reflector devices are constructed in several parts and only certain sections thereof can be lowered or moved down automatically or manually (initiated by a user of the installation). Preferably, individual sections in which one or more failed heating lamps have been detected can be lowered in this way. This offers the advantage that in an area where failed heating lamps have been detected, further damage to the oven or the elements of the oven can be prevented, but in the remaining areas of the oven the plastic preforms can continue to be heated and transported unhindered.

Particularly preferably, the bottom reflectors have a distance to the bottom tips of the plastic preforms to be heated which is less than 10 mm, preferably less than 8 mm and particularly preferably less than 5 mm.

In another preferred embodiment, the bottom reflectors are made of ceramic or a metal.

Preferably, the bottom reflectors have a high reflection. This reflection can be diffuse (especially when using ceramic) or specular (especially when using metal).

Preferably, an optimized reflection of the infrared radiation, in particular onto the bottom areas of the plastic preforms, i.e. in particular the bottom tips, is achieved by orienting the reflection surface(s) of the bottom reflectors towards the tips of the plastic preforms.

Particularly preferably, the counter-reflectors, which are arranged on the opposite side of the heating lane with respect to the heating lamps, are also adjustable in their position with respect to the plastic preforms.

The position of the counter-reflectors can thus be advantageously adapted to a geometric shape of the plastic preforms, in particular to a diameter of the plastic preforms. Preferably, a drive device is provided to adjust the positions of these counter-reflectors. However, manual adjustment is also conceivable. This adjustment can be stepped or stepless.

In a further preferred embodiment, the bottom reflector devices have a first section with a substantially horizontal course and a second section with the course deviating from the horizontal course.

In a preferred embodiment, the apparatus has a blocking device which is suitable and intended to prevent plastic preforms from entering the apparatus.

Particularly preferably, the blocking device is activated by a control device as soon as the failure of at least one heating lamp is detected by the detection device.

Already in the internal prior art, if one or more heating lamps failed, the preform lock was closed and the machines were run empty. After that, a hold mode was switched to. A lump created by a fallen plastic preform would be pushed through the heating lane in this way and could cause major machine damage.

In a preferred embodiment, the heating device has a plurality of (heating) zones which preferably extend along the transport direction of the plastic preforms and can be controlled and/or operated independently of one another. Preferably, at least one heating lamp and preferably a plurality of heating lamps are associated with each (heating) zone. Preferably, those heating lamps which are assigned to a (heating) zone are arranged one above the other and preferably in the longitudinal direction of the plastic preforms. It is conceivable that, depending on the type of plastic preform, not all (heating) zones are used to heat the plastic preforms or are only operated with reduced power. Furthermore, some heating lamps and/or (heating) zones may be in an inactive state at least temporarily.

In a preferred embodiment, it is possible that when a heating lamp fails, the blocking device is not activated immediately and, in particular, the preform block is not closed immediately. Instead, it is suggested that a (heating) zone or (inactive) heating lamp downstream of the failed heating lamp (downstream in the transport direction of the plastic preforms) is controlled and/or activated. This offers the advantage that the heating power of the failed heating lamp can be compensated by the additionally activated (heating) zone and/or heating lamp. It would also be conceivable to increase the power of a subsequent heating lamp accordingly to compensate for the failure of the heating lamp.

If, for example, no further inactive heating lamps are available for activation in the same (heating) zone in which the failure of a heating lamp is detected, it is conceivable that a heating lamp of an adjacent (heating) zone, in particular a subsequent (heating) zone in the transport direction of the plastic preforms, is activated.

In a preferred embodiment, the failed heating lamp as well as the heating lamp activated for compensation can be visually indicated to the user via a corresponding display and/or the user can be informed acoustically or visually that a heating lamp has failed and/or another heating lamp has been activated instead (inactive heating lamp) or the power of an already active heating lamp has been increased.

Furthermore, it is conceivable that such compensation can be activated and/or deactivated depending on the type, for example in the event that this is not desired due to high quality demands on the bottle. The proposed procedure offers the advantage that if a heating lamp fails, the machine does not have to stop (immediately) or run empty, but can continue production, for example until another heating lamp fails or until routine maintenance work is carried out. A message can then be issued to the operator accordingly and he can then prepare to replace the defective heating lamp.

In a preferred embodiment, the control device is designed in such a way that it causes the transport device to stop if more than one failure of heating lamps is detected, and in particular if more than one failure of heating lamps is detected within a certain time interval.

With the detection of multiple heating lamp failures according to the invention, if only one lamp fails, the preform lock would close as before and the machine would run empty as normal. However, if two or more heating lamps fail, an emergency stop is preferably triggered, which immediately brings the machine to a standstill. A possible lump of plastic preforms would not be pushed further through the machine and in this way would not cause any further damage.

Preferably, the control device also causes the remaining heating lamps to be switched off in the event of a failure of several heating lamps. Preferably, however, any cooling of the heating lamps is still maintained. In a preferred embodiment, it is conceivable that in the event of a failure of several heating lamps and in particular in the event that an emergency stop has been triggered, the power of the fans, which are preferably used for cooling the oven and/or the heating lamps, are operated at a maximum of their power. Preferably, the power is increased to a maximum automatically as soon as a failure of one or more heating lamps is detected and/or an emergency stop is triggered. This offers the advantage that overheating of the heating lamps during a machine standstill or further melting of fallen plastic preforms can be prevented or at least mitigated or delayed.

In a preferred embodiment, the apparatus comprises a detection device suitable and intended to detect a user's intervention in the machine after the transport device has stopped due to a failure of a plurality of heating lamps.

This is to ensure that a user is actually performing maintenance on the machine. For example, the control device can detect whether a machine cover over the heating lane has been opened. However, it would also be possible to detect movements of the user. Acknowledging a message and restarting the apparatus is preferably only possible after the heating device has been opened and the heating device has been checked.

The present invention is preferably also retrofittable to existing machines and in particular also achievable by a software modification.

The present invention is further directed to an plant for producing plastic containers with an apparatus of the type described above as well as a forming device arranged downstream of this apparatus in the transport direction of the plastic preforms for forming plastic preforms into plastic containers as well as a detection device which is suitable and intended for detecting (directly or indirectly) a detachment of a plastic preform from a holding device of the transport device.

Preferably, the holding devices described above are holding mandrels which can be inserted into the mouths of the plastic preforms.

In a preferred embodiment, in addition to the detection of the failure of heating lamps described above, the failure or falling of plastic preforms at a later time is also detected. For example, it can be detected after the oven that individual plastic preforms are missing. Here, too, the blocking device, which blocks the entry of plastic preforms into the heating device, can be activated. In this case, a warning can also be issued to the user, informing him that plastic preforms may have to be removed from the heating device.

The present invention is further directed to a method for heating plastic preforms, wherein the plastic preforms are transported along a predetermined transport path by a transport device, and wherein the transport device comprises a circulating transport device and a plurality of holding devices, which hold the plastic preforms and wherein a plurality of heating devices, which are arranged stationarily along the transport path, heat the plastic preforms transported along the transport path and wherein the heating devices each comprise a plurality of heating lamps and wherein a detection device of the apparatus detects a failure of one or more heating lamps.

According to the invention, the apparatus comprises a control device which controls the apparatus in dependence on a number of the heating lamps detected as having failed.

Thus, as mentioned above, it is possible that if failures or more failures are detected in a certain time interval, an emergency stop of the machine is initiated.

Particularly preferably, a detachment of plastic preforms from their holding devices is also detected by means of a second detection device. This detection is particularly preferred after the heating device.

In a preferred method, the plastic preforms are transported individually. Particularly preferably, the plastic preforms are rotated with respect to their longitudinal direction in order to achieve uniform heating.

In a further preferred method, when a failure of two or more heating lamps is detected, the transport device is stopped and/or an emergency stop is initiated. Particularly preferably, this is initiated if two or more failures of heating lamps are detected within a predetermined period of time.

Preferably, this period is less than 10 min, preferably less than 8 min, preferably less than 6 min, preferably less than 4 min, preferably less than 2 min, preferably less than 1 min, preferably less than 30 sec, preferably less than 20 sec, preferably less than 10 sec, and preferably less than 5 sec.

Particularly preferably, when the failure of a heating lamp is detected, an inlet of the plastic preforms into the heating device is blocked. This can be done in particular with a plastic preform block located in front of the heating device. However, it would also be possible to merely issue warnings.

Particularly preferably, a failure of individual heating lamps is detected on the basis of electrical variables, in particular on the basis of flowing currents and/or applied voltages.

In a further preferred method, a time interval of a failure of two or more heating lamps is detected and preferably a stop of the transport device is effected if this time interval falls below a predetermined limit value.

Particularly preferably, the failed heating lamp is identified and/or assigned to a specific heating device. In this way, the user can be informed exactly which heating lamp of which heating device has failed, for example the third heating lamp from the top of the fourth heating device along the transport path of the plastic preforms.

Particularly preferably, a detection device thus determines a position of the failed heating lamp.

### BRIEF DESCRIPTION OF THE DRAWINGS

Further advantages and embodiments can be seen in the attached drawing:

FIG. 1 a schematic representation of an apparatus according to the invention;

FIG. 2a,b two representations of heating lanes according to the prior art;

FIG. 3a,b two representations of heating lanes of an apparatus according to the invention;

FIG. 4a a bottom reflector according to the prior art;

FIG. 4b an advantageous bottom reflector; and

FIG. 4c a further advantageous bottom reflector.

### DETAILED DESCRIPTION OF THE INVENTION

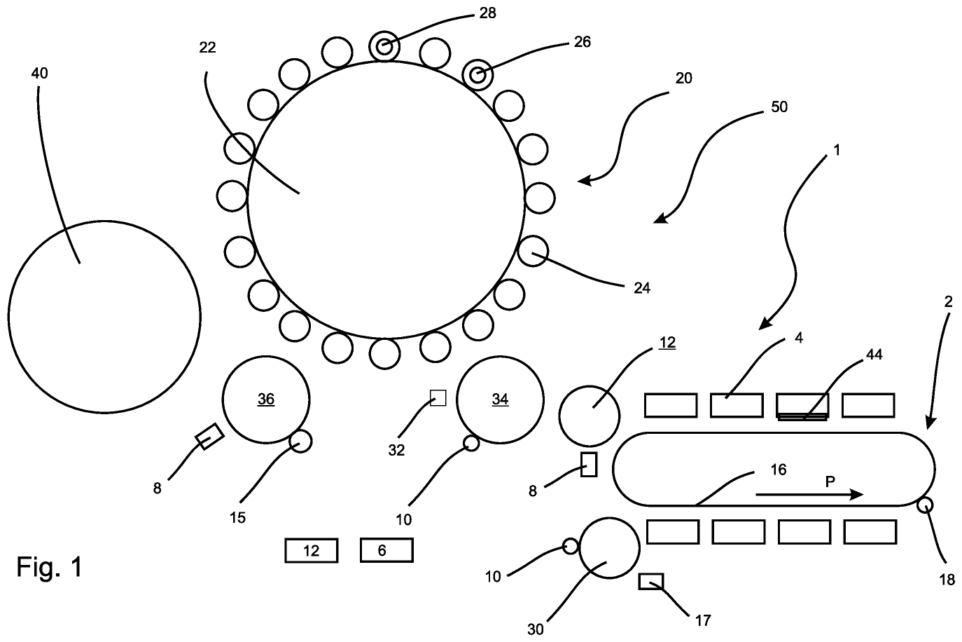

FIG. 1 shows a representation of a plant 50 for producing plastic containers, which has an apparatus 1 according to the invention for heating plastic preforms and a forming device 20 arranged downstream thereof for forming plastic preforms into plastic containers.

The forming device 20 for forming plastic preforms 10 into plastic containers 15 has a transport device 22, such as in particular a blowing wheel, on which a plurality of forming stations 24 are arranged. These forming stations each have blow moulds 26 within which the plastic preforms are formed into the plastic containers. In addition, the forming stations 24 can each have stretching rods which can be inserted into the plastic preforms and which cause the plastic preforms to stretch in their longitudinal direction.

Reference sign 32 schematically indicates a detection device which detects whether a plastic preform is arranged on a holding device.

A feed device 34 feeds the heated plastic preforms to the forming device 20 and a discharge device 36 discharges the manufactured plastic containers 15 from the forming device 20. The reference sign 40 indicates a filling device which is suitable and intended for filling the plastic containers 15 with a liquid and in particular a beverage.

The heating device 1 also has a transport device 16, which is designed here as a circulating transport chain. A number of holding devices 18 are arranged on this transport device, each of which holds a plastic preform. The reference sign 2 identifies the transport device in its entirety. The plastic preforms are transported along a transport path P. As mentioned above, the holding devices 18 are each designed as holding mandrels which can be inserted into the plastic preforms.

The reference sign 4 indicates a stationary heating device. In this design, for example, eight such heating devices are arranged along the transport path P of the containers. Each heating device has a plurality of heating lamps 44 (only one shown schematically). These also extend along the transport path P.

The reference sign 30 indicates a single-cycle star that separates the plastic preforms 10 and feeds them to the transport device 2.

The reference sign 12 indicates a blocking device with which the supply of plastic preforms to the transport device 2 or the heating device 1 can be stopped.

The reference sign 6 roughly schematically indicates a detection device which is suitable and intended to detect the failure of individual heating lamps 44. The reference sign 12 indicates a control device which controls the transport device 2 and/or the heating device 1 as a function of signals detected by the detection device.

If a failure of a single heating lamp 44 is detected, the preform lock 12 can be activated and the further infeed of plastic preforms can be prevented. If the failure of two heating lamps is detected at a certain time interval, the transport device 2 can be stopped at the same time. Subsequently, the heating device can be opened and a possible fault can be eliminated.

Restarting the transport device is only possible after a fault has been rectified and/or a user acknowledges the repair or maintenance.

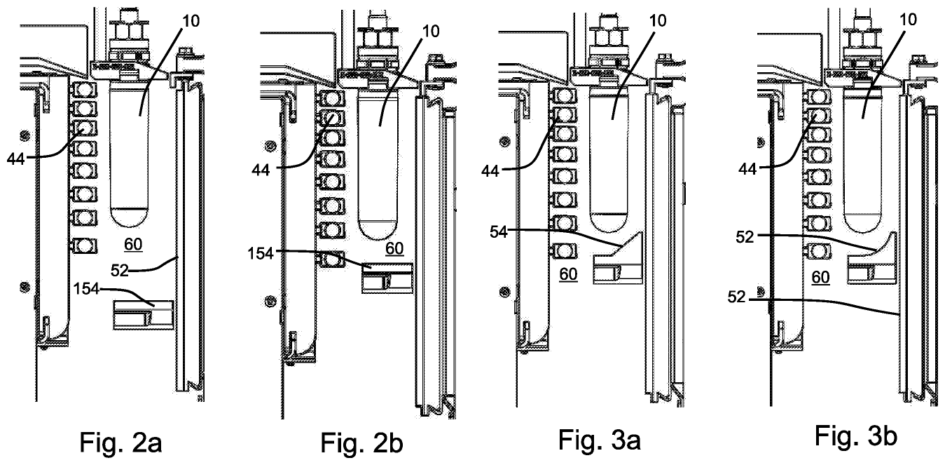

FIG. 2a and 2b show two illustrations of a prior art heating lane 60. Here, several heating lamps 44 are provided, which are arranged one above the other in the longitudinal direction of the plastic preforms 10.

The reference sign 52 indicates a counter-reflector which is opposite the heating lamps with respect to the plastic preforms 10. Part of the heat radiation emitted by the heating lamps is reflected by this counter-reflector onto the plastic preforms.

Reference sign 154 indicates a bottom reflector which is used to heat the bottom area of the plastic preforms. However, there is a considerable “dead space” above the bottom reflector which cannot be used for heating the plastic preforms.

In the embodiment shown in FIG. 2b, the heating alley is already significantly narrowed. Here, the bottom reflector 154 is closer to the plastic preforms. Here, too, there is still a considerable dead space above the bottom reflector on the right-hand side.

FIG. 3a shows an embodiment with a bottom reflector according to the invention in a first embodiment. This bottom reflector here has an obliquely extending section. In this way, the bottom reflector 54 can be brought closer to the plastic preforms 10. In this embodiment, the “dead space” occurring in the heating lane 60 is considerably reduced.

In particular, there is a small distance between the counter tile or counter reflector and the plastic preforms and also a small distance between the top areas of the plastic preforms and the bottom reflector 54. This short distance is achieved by a combination of several flat surfaces.

FIG. 3b shows another advantageous design of the bottom reflector 54. Here, the reduced dead space is achieved by a combination of a flat horizontal surface and a spherical surface.

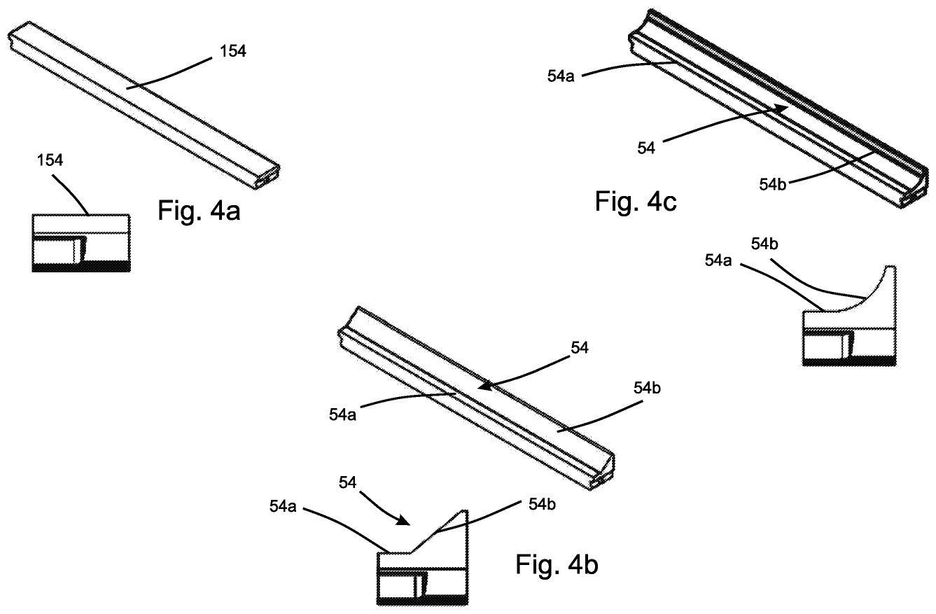

FIG. 4a shows an illustration of a bottom reflector or floor tile according to the prior art. It can be seen that its surface is completely flat.

In FIG. 4b, a bottom reflector 54 according to the invention is shown in a first embodiment. In this embodiment. In this embodiment, the bottom reflector has a flat section 54a followed by an inclined section 54b. This flat section is also straight but slanted. The flat section 54a and the inclined section 54b preferably enclose an angle that is smaller than 180°, preferably smaller than 160°. Preferably, however, this angle is greater than 90° and preferably greater than 120°. Preferably, therefore, the bottom reflect or here is composed of a combination of several, in this case two, flat surfaces.

FIG. 4c shows another advantageous design of a bottom reflector. Here, a horizontal section 54a is combined with a spherical section 54b. Overall, the floor reflector here has a concave shape.

Preferably, the bottom reflectors extend along the transport path of the plastic preforms.

The applicant reserves the right to claim all features disclosed in the application documents as essential to the invention, provided that they are individually or in combination new compared to the prior art. It is further pointed out that the individual figures also describe features which may be advantageous in themselves. The skilled person immediately recognizes that a certain feature described in a figure can also be advantageous without adopting further features from this figure. Furthermore, the skilled person recognizes that advantages can also result from a combination of several features shown in individual figures or in different figures.

1. An apparatus for heating plastic preforms, having a transport device which transports the plastic preforms along a predetermined transport path, the transport device having a circulating transport device and a plurality of holding devices for holding the plastic preforms, having a plurality of heating devices which are arranged stationarily along the transport path, in such a way that the plastic preforms transported along the transport path are heated by these heating devices, the heating devices each having a plurality of heating lamps, and the apparatus having a detection device configured to detect a failure of the heating lamps,
wherein
the apparatus has a control device which is configured to control the apparatus in dependence on a number of heating lamps detected having failed.

2. The apparatus according to claim 1,
wherein
the apparatus has a detection device configured to detect a time interval between the failures of at least two heating lamps.

3. The apparatus according to claim 1,
wherein
the apparatus comprises a first heating lane through which the plastic preforms are transported during their heating.

4. The apparatus according to claim 3,
wherein
a plurality of reflector devices are arranged in the heating lane, which are configured to reflect thermal radiation, with bottom reflector devices also being provided, which are arranged below the plastic preform to be transported.

5. The apparatus according to claim 4,
wherein
the bottom reflector devices have, at least in sections, a course which deviates from a horizontal course.

6. The apparatus according to claim 5,
wherein
the bottom reflector devices have a first portion with a substantially horizontal course and a second portion with the course deviating from the horizontal course.

7. The apparatus according to claim 1,
wherein
the apparatus has a blocking device which is configured to for preventing the entry of plastic preforms into the apparatus.

8. The apparatus according to claim 1,
wherein
the control device is designed in such a way that it causes the transport device to stop if more than two failures of heating lamps are detected.

9. The apparatus according to claim 1,
wherein
the apparatus comprises a detection device, which is configured to detect an intervention of a user in the machine after a stop of the transport device due to a failure of several heating lamps.

10. A plant for producing plastic preforms, having an apparatus according to claim 1 and a forming device, arranged downstream of this apparatus in the transport direction of the plastic preforms, for forming plastic preforms into plastic containers, and having a detection device configured to detect the detachment of a plastic preform from a holding device of the transport device.

11. The method for heating plastic preforms, wherein the plastic preforms are transported along a predetermined transport path by a transport device, wherein the transport device has a circulating transport device and a plurality of holding devices which hold the plastic preforms, and wherein a plurality of heating devices, which are arranged stationarily along the transport path, heat the plastic preforms transported along the transport path, wherein the heating devices each comprise a plurality of heating lamps, and wherein a detection device of the device detects a failure of heating lamps,
wherein
the apparatus comprises a control device which controls the apparatus in dependency on a number of the heating lamps detected as having failed.

12. The method according to claim 11,
wherein
when a failure of two or more heating lamps is detected, the transport device is stopped.

13. The method according to claim 11,
wherein
a time interval of a failure of two or more heating lamps is detected and a stop of the transport device is effected if this time interval falls below a predetermined limit value.

14. The method according to claim 11,
wherein
the detection device determines a position of the failed heating lamp.
